(19) United States
(12) Patent Application Publication
(10) Pub. No.: US 2024/0337805 A1
(43) Pub. Date: Oct. 10, 2024

(54) MITIGATION OF ATTENUATING EFFECTS FROM IONIZING RADIATION IN SILICA OPTICAL FIBERS BY PHOTOBLEACHING

(71) Applicant: Commonwealth Fusion Systems LLC, Devens, MA (US)

(72) Inventors: Owen Beals Duke, Cambridge, MA (US); Erica Elizabeth Salazar, Somerville, MA (US); David Paul Meichle, Cambridge, MA (US)

(73) Assignee: Commonwealth Fusion Systems LLC, Devens, MA (US)

(21) Appl. No.: 18/708,165

(22) PCT Filed: Nov. 21, 2022
(86) PCT No.: PCT/US2022/050549

§ 371 Date: May 7, 2024

Related U.S. Application Data
(60) Provisional application No. 63/282,503, filed on Nov. 23, 2021.

(51) Int. Cl. G02B 6/46; H01B 12/04; H01F 6/02

(52) U.S. Cl. CPC G02B 6/562; H01B 12/04; H01F 6/02

(57) ABSTRACT

Systems and methods for performing optical annealing of an optical fiber disposed in a cryogenic environment subject to ionizing radiation, such as in a fusion energy source, are provided. The techniques include optically annealing the optical fiber using first light having a first peak wavelength and second light having a second peak wavelength different than the first peak wavelength. The first and second peak wavelengths may be selected to optically anneal defects associated with transient radiation-induced attenuation (RIA) and permanent RIA.

### RELATED APPLICATIONS

This application claims the benefit of U.S. Provisional Patent Application Ser. No. 63/282,503, titled “MITIGATION OF ATTENUATING EFFECTS FROM IONIZING RADIATION IN SILICA OPTICAL FIBERS BY PHOTOBLEACHING,” filed on Nov. 23, 2021, which is incorporated by reference in its entirety herein.

### BACKGROUND

Optical fibers are flexible, transparent fibers used as a means to transmit light between the two ends of the fiber. Optical fibers typically include a core surrounded by a cladding material with a lower index of refraction than the core. Light is kept in the core of the optical fiber—and is able to be transmitted along the length of an optical fiber—because of the phenomenon of total internal reflection. Optical fibers are commonly used in fiber-optic communications, for illumination and imaging, and in fiber optic sensing applications.

### SUMMARY

Some embodiments are directed to a system arranged to perform optical annealing of an optical fiber disposed in an environment subject to ionizing radiation. The system comprises: a first light source configured to illuminate and optically anneal the optical fiber by generating first light having a first peak wavelength; a second light source configured to illuminate and optically anneal the optical fiber by generating second light having a second peak wavelength; and an optical multiplexer coupled between the first light source and the optical fiber and between the second light source and the optical fiber.

In some embodiments, the first light source is configured to generate the first light having the first peak wavelength in a range from 770 nm to 1170 nm. In some embodiments, the first light source is configured to generate the first light having the first peak wavelength of approximately 970 nm.

In some embodiments, the second light source is configured to generate the second light having the second peak wavelength in a range from 1350 nm to 1750 nm. In some embodiments, the second light source is configured to generate the second light having the second peak wavelength of approximately 1550 nm.

In some embodiments, the first light source is configured to generate the first light having an optical power in a range from 5 mW to 500 mW.

In some embodiments, the optical multiplexer is configured to perform wavelength-division multiplexing (WDM) of the first light and the second light.

In some embodiments, the optical multiplexer is configured to perform time-division multiplexing (TDM) of the first light and the second light.

In some embodiments, the optical multiplexer is configured to simultaneously illuminate the optical fiber with the first light and the second light.

In some embodiments, the optical multiplexer is configured to illuminate the optical fiber with the first light and the second light in an alternating sequence.

In some embodiments, the system is arranged to illuminate the optical fiber using the first light source and/or second light source while the optical fiber is exposed to the ionizing radiation.

In some embodiments, the optical fiber is disposed in a cryogenic environment while illuminated by the first light source and/or the second light source. In some embodiments, the optical fiber is at a temperature between 0K and 120K while illuminated by the first light source and/or the second light source.

In some embodiments, the optical fiber extends along a length of a high temperature superconductor (HTS) cable, the HTS cable comprising at least one HTS tape stack.

In some embodiments, the system is used in a fusion energy system.

In some embodiments, the ionizing radiation is manmade ionizing radiation. In some embodiments, a dose rate of the ionizing radiation on the environment is greater than a dose rate of background ionizing radiation. In some embodiments, the dose rate of the ionizing radiation is greater than 0.2 nGy/s.

Some embodiments are directed to a method of optically annealing an optical fiber disposed in an environment subject to ionizing radiation. The method comprises: optically annealing the optical fiber with first light having a first peak wavelength; and optically annealing the optical fiber with second light having a second peak wavelength.

In some embodiments, optically annealing the optical fiber with the first light and the second light comprises optically annealing the optical fiber with the first light and the second light simultaneously.

In some embodiments, optically annealing the optical fiber with the first light and the second light comprises optically annealing the optical fiber with the first light and the second light in an alternating sequence.

In some embodiments, optically annealing the optical fiber with the first light and the second light comprises multiplexing the first light and the second light onto the optical fiber.

In some embodiments, multiplexing the first light and the second light onto the optical fiber comprises using wavelength-division multiplexing (WDM).

In some embodiments, multiplexing the first light and the second light onto the optical fiber comprises using time-division multiplexing (TDM).

In some embodiments, optically annealing the optical fiber with the first and/or second light comprises optically annealing the optical fiber with the first and/or second light while the optical fiber is exposed to the ionizing radiation.

In some embodiments, optically annealing the optical fiber with the first light comprises illuminating the optical fiber with first light having a peak wavelength in a range from 770 nm to 1170 nm. In some embodiments, optically annealing the optical fiber with the first light comprises optically annealing the optical fiber with first light having a peak wavelength of approximately 970 nm.

In some embodiments, optically annealing the optical fiber with the second light comprises optically annealing the optical fiber with second light having a peak wavelength in a range from 1350 nm to 1750 nm. In some embodiments, optically annealing the optical fiber with the second light comprises optically annealing the optical fiber with second light having a peak wavelength of approximately 1550 nm.

In some embodiments, optically annealing the optical fiber with the first light and/or the second light comprises optically annealing the optical fiber with the first light and/or the second light while the optical fiber is disposed in a cryogenic environment.

In some embodiments, optically annealing the optical fiber with the first light and/or the second light comprises optically annealing the optical fiber with the first light and/or the second light while the optical fiber is at a temperature between 0K and 120K.

In some embodiments, optically annealing the optical fiber with the first light and/or the second light comprises optically annealing the optical fiber with the first light and/or the second light while the optical fiber is disposed along a length of a high temperature superconductor (HTS) cable, the HTS cable comprising at least one HTS tape stack.

In some embodiments, optically annealing the optical fiber with the first light and/or the second light comprises optically annealing the optical fiber with the first light and/or the second light while the optical fiber is used in a fusion energy system.

Some embodiments are directed to a system arranged to perform optical annealing of an optical fiber. The system comprises: a first light source configured to optically anneal the optical fiber by generating first light having a first peak wavelength; a second light source configured to optically anneal the optical fiber by generating second light having a second peak wavelength; and an optical multiplexer coupled between the first light source and the optical fiber and between the second light source and the optical fiber, wherein: the optical fiber is disposed in a fusion energy source, the optical fiber is subject to ionizing radiation created by the fusion energy source while the first light source and/or the second light source optically anneal the optical fiber, and the optical fiber is at a cryogenic temperature.

In some embodiments, the first light source is configured to generate the first light having the first peak wavelength in a range from 770 nm to 1170 nm. In some embodiments, the first light source is configured to generate the first light having the first peak wavelength of approximately 970 nm.

In some embodiments, the second light source is configured to generate the second light having the second peak wavelength in a range from 1350 nm to 1750 nm. In some embodiments, the second light source is configured to generate the second light having the second peak wavelength of approximately 1550 nm.

In some embodiments, the first light source is configured to generate the first light having an optical power in a range from 5 mW to 500 mW.

In some embodiments, the optical multiplexer is configured to perform wavelength-division multiplexing (WDM) of the first light and the second light.

In some embodiments, the optical multiplexer is configured to perform time-division multiplexing (TDM) of the first light and the second light.

In some embodiments, the optical multiplexer is configured to simultaneously illuminate the optical fiber with the first light and the second light.

In some embodiments, the optical multiplexer is configured to illuminate the optical fiber with the first light and the second light in an alternating sequence.

In some embodiments, the optical fiber is at a temperature between 0K and 120K while illuminated by the first light source and/or the second light source.

In some embodiments, the optical fiber extends along a length of a high temperature superconductor (HTS) cable, the HTS cable comprising at least one HTS tape stack.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a schematic diagram of a system for optically annealing an optical fiber, in accordance with some embodiments described herein.

FIG. 2A is a plot illustrating optical annealing effects of two peak wavelengths of light on a first optical fiber, in accordance with some embodiments described herein.

FIG. 2B is a plot illustrating optical annealing effects of two peak wavelengths of light on a second optical fiber, in accordance with some embodiments described herein.

FIG. 3 is a plot illustrating optical annealing effects of light applied to an optical fiber with different values of optical power, in accordance with some embodiments described herein.

FIG. 4 is a flowchart of a process of optically annealing an optical fiber disposed in an environment subject to ionizing radiation, in accordance with some embodiments described herein.

FIG. 5 is a schematic diagram of a system for detecting a quench event in a superconducting material and for optically annealing an optical fiber used for detecting the quench event, in accordance with some embodiments described herein.

FIGS. 6A and 6B show views of a high-temperature superconductor (HTS) cable, in accordance with some embodiments described herein.

FIG. 7 is a perspective view of a HTS tape stack, in accordance with some embodiments described herein.

FIG. 8A is a cross-sectional view of a HTS cable including optical fibers for quench detection, in accordance with some embodiments described herein.

FIG. 8B is a close-up view of the optical fibers of FIG. 8A in accordance with some embodiments described herein.

FIG. 8C is a cross-sectional view of another HTS cable including optical fibers for quench detection, in accordance with some embodiments described herein.

FIG. 8D is a close-up view of the optical fibers of FIG. 8C in accordance with some embodiments described herein.

FIG. 9 is a schematic diagram of an illustrative computing device, in accordance with some embodiments described herein.

FIG. 10 is a cross-sectional view of an illustrative tokamak, in accordance with some embodiments described herein.

### DETAILED DESCRIPTION

Fusion energy is a possible solution to the global need for clean energy. Fusion energy is safe, energy-dense, and produces no greenhouse gas emissions. In a fusion reaction, light atomic nuclei (e.g., hydrogen) are combined to form heaver nuclei (e.g., helium), producing energy. Magnetic confinement is an approach to generate fusion power that uses magnetic fields to confine a plasma to produce conditions under which the plasma will undergo fusion. Very high plasma temperatures, on the order of 150 million° C., may be required to initiate fusion reactions, and the plasma may be heated through operation of the magnetic fields and external heating methods.

The reactor design known as a tokamak is one approach to magnetic confinement that seeks to address the problematic instabilities that can result in the plasma during heating and/or during fusion reactions. In a tokamak, the plasma is confined in a toroid, and instabilities in the plasma are controlled by arranging magnetic fields to cause particles of the plasma to transit between the inner and outer sides of the toroid multiple times per orbit. This “twist” in the magnetic fields dramatically improves the stability of the plasma. To control the plasma in a tokamak, magnets are used to create toroidal and poloidal fields that shape and position the plasma within the toroid, as well as drive motion of the plasma around the toroid.

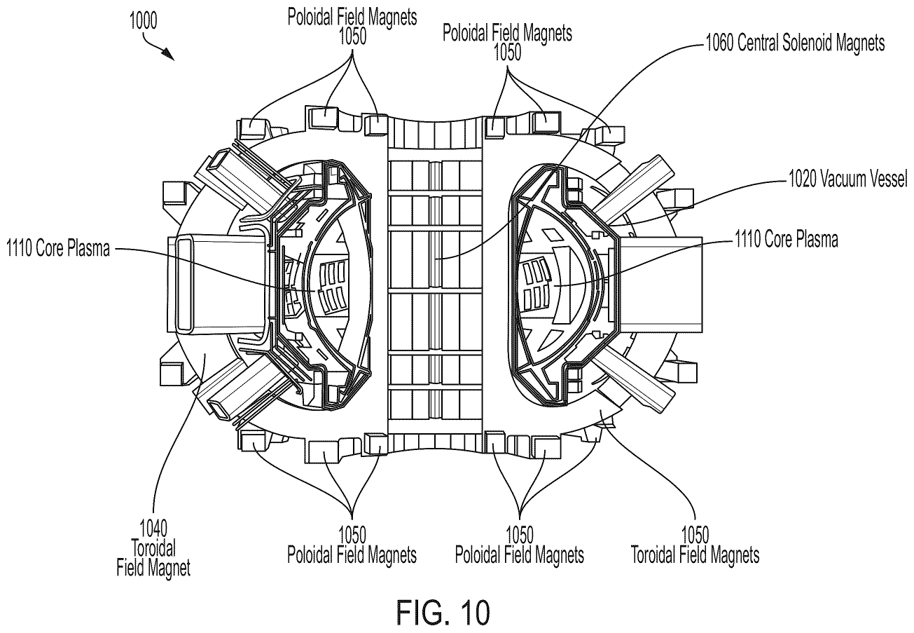

An overview of some of aspects of an illustrative tokamak is shown in FIG. 10, which depicts a cross-sectional view of the tokamak 1000, according to some embodiments. As shown in FIG. 10, in tokamak 1000, the core plasma 1010 circulates within a vacuum vessel 1020, which is shaped as a toroid. The tokamak 1000 also includes a plurality of toroidal field (TF) magnets 1040, a plurality of poloidal field (PF) magnets 1050, and one or more central solenoid (CS) magnets 1060. The TF magnets 1040 are D-shaped (or approximately D-shaped) magnets that are configured to confine the plasma 1010 in a desired region of the vacuum vessel 1020, and to generate flux within the plasma. The PF magnets 1050 are roughly ring-shaped magnets that are configured to shape and position the plasma 1010. The CS magnet(s) 1060 are arranged in the center of the tokamak and are configured to inductively drive the plasma current.

During operation of the tokamak 1000, an axisymmetric toroidal plasma 1010 is produced in the vacuum vessel 1020. This plasma carries a toroidal current, which in turn creates a poloidal magnetic field, providing confinement of the plasma. The TF magnets 1040 provide stability to the plasma current, with the PF magnets 1050 and the CS magnets 1060 shaping and controlling the position of the plasma. The plasma is heated by the CS magnets 1060, radio frequency (RF) signals, and/or high energy neutral beams to initiate fusion, and energy from the resulting neutrons are captured in the blanket, which is a structure containing low atomic number atoms, such as lithium, that will readily collide with neutrons to capture energy.

The TF magnets 1040, PF magnets 1050, and/or CS magnets 1060 include one or more conductor windings within the illustrated housings. These magnets generally utilize superconducting materials that are cooled cryogenically to produce a high magnetic field. According to some embodiments, these conductors may include a high temperature superconductor (HTS) (e.g., rare-earth barium copper oxides (ReBCOs)). As used herein the phrases “HTS materials” or “HTS superconductors” refer to superconducting materials having a critical temperature above 30K at zero self-field.

A superconducting magnet often comprises multiple electrically insulated cable turns grouped in a multi-layer arrangement. When the superconducting material is cold enough to be below its critical temperature (the temperature below which the electrical resistivity of the material drops to near zero), driving the magnet allows current to pass through the superconducting path without losses. However, for various reasons, some or all of the superconducting material may be heated to above its critical temperature and therefore lose its superconducting characteristics. If uncontrolled, such heating can lead to the superconductor losing its superconducting abilities, often referred to as a “quench.” Moreover, if the quench is not properly addressed by the system (e.g., by shutting down), components can be damaged by the heating. There is accordingly a need to monitor the temperature of superconducting materials during operation in order to detect a quench in order to mitigate the effects of a quench.

Some superconducting magnet systems handle quench events via a system of active alarms and detection mechanisms, such as detection of voltages at different points of the superconductor. However, sensing wires for such electricity-based quench detection techniques are highly prone to electromagnetic interference generated by the variable magnetic fields present in a tokamak reactor during its operation. As an alternative, optical sensing techniques (e.g., using optical fibers) may be used to perform quench detection in fusion reactor environments because optical signals are immune to such interference effects.

The inventors have recognized and appreciated that optical fibers that are exposed to ionizing radiation, such as is present in a tokamak, can exhibit significant radiation-induced attenuation (RIA). RIA is caused by material defects introduced into the atomic structure of the optical fibers; these defects cause scattering of the transmitted light, leading to attenuation of the transmitted optical signals and less sensitive optical sensing systems. At temperatures greater than cryogenic temperatures (e.g., room temperature, greater than room temperature) at least some these introduced defects can “self-heal” using environmental thermal energy.

However, in cryogenic environments (e.g., environments at a temperature in a range from 0 K to 120 K), there is not sufficient environmental thermal energy to allow an optical fiber to self-heal these introduced defects, and the optical fiber may therefore exhibit an increasing RIA over time, reducing in functionality. In cryogenic environments, optical energy can augment or substitute for thermal energy to heal defects introduced by ionizing radiation into the optical fiber. Optical annealing can therefore be utilized to reduce RIA of the optical fiber, allowing for use of the optical fiber as a sensor or signal transmission line in cryogenic environments subject to ionizing radiation.

RIA can be caused by two different types of RIA: permanent RIA and transient RIA. Permanent RIA includes defects with a larger trapping energy that persist even with thermal annealing at room temperature. Transient RIA, on the other hand, includes defects with a lower trapping energy that do not persist when thermally annealed at room temperature. The effects of permanent RIA are roughly proportional to a total dose of ionizing radiation, whereas the effects of transient RIA are roughly proportional to the dose rate. The inventors have recognized and appreciated that the unique operating conditions of a tokamak increase the prevalence and effect of transient RIA in addition to the effects of permanent RIA. During operation of a tokamak, optical fibers for quench detection of the tokamak magnets may experience a dose rate of approximately 0.1 to 20 Gy/s for a short operative period (e.g., approximately 10 seconds, in some embodiments). During this operative period, the optical fiber is being used to monitor the temperature of the tokamak magnets for quench detection. However, the optical fiber is also being held at a cryogenic temperature such that material defects causing transient RIA cannot thermally anneal, thereby impacting the functionality of an optical-fiber-based quench detection system.

Thus, for performing optical sensing in a cryogenic environment subject to high dose rates of ionizing radiation, mitigating the effects of both transient and permanent RIA is important for maintaining the functionality of the optical sensing system. The inventors have recognized and appreciated that performing optical annealing of the optical fiber using at least two peak wavelengths of light can provide optical annealing to combat effects of both transient and permanent RIA. Accordingly, the inventors have developed a system to perform optical annealing of an optical fiber disposed in a cryogenic environment subject to ionizing radiation. In some embodiments, the system includes a first light source, a second light source, and an optical multiplexer. The first light source is configured to illuminate and optically anncal the optical fiber by generating light having a first peak wavelength, and the second light source is configured to illuminate and optically anneal the optical fiber by generating light having a second peak wavelength different than the first peak wavelength. In some embodiments, the system is arranged to illuminate the optical fiber using the first light source and/or second light source while the optical fiber is exposed to the ionizing radiation. In some embodiments, the optical fiber is disposed in a cryogenic environment (e.g., having a temperature in a range from 0 K to 120 K) while being illuminated by the first and/or second light source.

In some embodiments, the optical multiplexer is coupled between the first light source and the optical fiber and between the second light source and the optical fiber. The optical multiplexer may be configured to perform, for example, wavelength-division multiplexing (WDM) and/or time-division multiplexing (TDM) of the first light and the second light. As one example, the optical multiplexer may be configured to simultaneously illuminate the optical fiber with the first light and second light. As another example, the optical multiplexer may be configured to illuminate the optical fiber with the first light and the second light in an alternating sequence (e.g., illuminating the optical fiber with the first light followed by illuminating the optical fiber with the second light, or vice versa).

In some embodiments, the first light source and the second light source are configured to generate light having different and distinct peak wavelengths. The first light source may be configured to generate first light having a first peak wavelength in a range from 770 nm to 1170 nm, in a range from 700 nm to 1170 nm, in a range from 600 nm to 1100 nm, in a range from 500 nm to 1100 nm, or in a range from 850 nm to 1050 nm, for example. Any suitable combination of the above ranges is also possible (e.g., a first peak wavelength in a range from 600 nm to 1170 nm). For example, the first light source may be configured to generate first light having a first peak wavelength of approximately 970 nm. As additional examples, the first light source may be configured to generate first light having a first peak wavelength of approximately 650 nm. 800 nm, or 1060 nm.

In some embodiments, the second light source may be configured to generate second light having a second peak wavelength in a range from 1350 nm to 1750 nm, in a range from 1400 nm to 1700 nm, in a range from 1450 nm to 1650 nm, or any suitable range within those ranges. For example, the second light source may be configured to generate second light having a second peak wavelength of approximately 1550 nm. As another example, the second light source may be configured to generate second light having a second peak wavelength of 1600 nm.

In some embodiments, the first light source and/or the second light source are configured to generate light having an optical power in a range from 5 mW to 1 W, in a range from 5 mW to 500 mW, in a range from 10 mW to 600 mW, in a range from 15 mW to 500 mW, or any suitable range within those ranges. For example, the first light source and/or the second light source may be configured to generate light having an optical power of approximately 10 mW, 20 mW, 50 mW, 100 mW, 200 mW, 250 mW, and/or 500 mW.

In some embodiments, the optical fiber is disposed in a fusion energy source. For example, the optical fiber may be arranged to operate as a temperature and/or strain sensor configured to detect quench events of a high-temperature superconductor (HTS) of the fusion energy source. The HTS may be, for example, a HTS cable including at least one HTS tape stack. The optical fiber may also be disposed in a cryogenic environment at a temperature below a critical temperature of the HTS.

In some embodiments, the optical fiber may be disposed in an environment subject to ionizing radiation. For example, the ionizing radiation may be generated by an artificial or humanmade source (e.g., a fusion energy source). The ionizing radiation incident on the optical fiber may have a dose rate greater than a dose rate of background ionizing radiation (e.g., from cosmic rays and other background ionizing radiation sources). For example, the ionizing radiation incident on the optical fiber may have a dose rate greater than the average background dose rate (e.g., approximately 0.2 nGy/s in the United States). As another example, the ionizing radiation incident on the optical fiber may have a dose rate in a range from approximately 5 Gy/s to 30 Gy/s.

Following below are more detailed descriptions of various concepts related to, and embodiments of, techniques for quench detection. It should be appreciated that various aspects described herein may be implemented in any of numerous ways. Examples of specific implementations are provided herein for illustrative purposes only. In addition, the various aspects described in the embodiments below may be used alone or in any combination and are not limited to the combinations explicitly described herein.

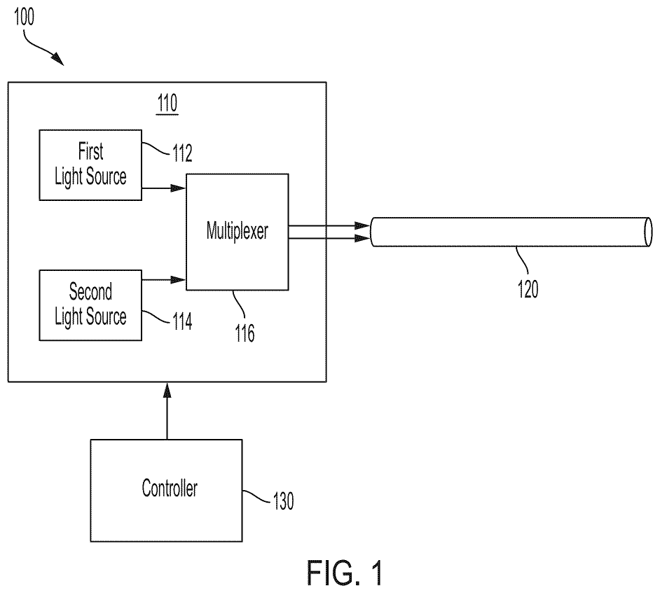

FIG. 1 is a schematic diagram of a system 100 for optically annealing an optical fiber, in accordance with some embodiments described herein. The system 100 includes an optical system 110 optically coupled to an optical fiber 120 and a controller 130 communicatively coupled to the optical system 110. The optical system 110 includes a first light source 112, a second light source 114, and an optical multiplexer 116. It should be appreciated that while only two light sources are depicted in the example of FIG. 1, in some embodiments the system 100 may include a different number of light sources, such as three or more light sources, as aspects of the technology described herein are not limited in this respect.

In some embodiments, the system 100 is arranged to illuminate the optical fiber 120 using the first light source 112 and/or second light source 114 while the optical fiber 120 is exposed to the ionizing radiation. The optical fiber 120 may be exposed to ionizing radiation having a dose rate greater than a dose rate of background ionizing radiation (e.g., from cosmic rays and/or other natural sources of ionizing radiation). For example, the dose rate of the ionizing radiation may be greater than 0.2 nGy/s. In some embodiments, the ionizing radiation may be manmade or artificial ionizing radiation. For example, the system 100 may be implemented in a fusion energy system.

In some embodiments, the optical fiber 120 may be disposed in a cryogenic environment while illuminated by the first light source 112 and/or the second light source 114. For example, the optical fiber 120 may be in an environment that is at a temperature in a range between 0K and 120K while illuminated by the first light source 112 and/or the second light source 114.

In some embodiments, the optical fiber 120 may be an optical fiber suitable for supporting wavelengths of light for telecommunications. For example, the optical fiber 120 may be a pure silica-core fiber (e.g., a radiation-hardened optical fiber). As another example, the optical fiber 120 may be a standard germanium-doped optical fiber. In some embodiments, the optical fiber 120 may be an optical fiber suitable for sensing applications (e.g., sensing temperature and/or strain).

In some embodiments, the first light source 112 and the second light source 114 are configured to illuminate the optical fiber 120 to perform optical annealing of the optical fiber 120. The first light source 112 may be configured to generate light having a first peak wavelength, and the second light source 114 may be configured to generate light having a second peak wavelength different than the first peak wavelength.

In some embodiments, the first light source 112 may be configured to generate light having a first peak wavelength in a range from 770 nm to 1170 nm, in a range from 700 nm to 1170 nm, in a range from 600 nm to 1100 nm, in a range from 500 nm to 1100 nm, in a range from 850 nm to 1050 nm. Any suitable combination of the above ranges is also possible (e.g., a first peak wavelength in a range from 600 nm to 1170 nm). For example, the first light source may be configured to generate first light having a first peak wavelength of approximately 970 nm. As additional examples, the first light source may be configured to generate first light having a first peak wavelength of approximately 650 nm, 800 nm, or 1060 nm.

In some embodiments, the second light source 114 may be configured to generate light having a first peak wavelength in a range from 1350 nm to 1750 nm, in a range from 1400 nm to 1700 nm, in a range from 1450 nm to 1650 nm, or any suitable range within those ranges. For example, the second light source may be configured to generate second light having a second peak wavelength of approximately 1550 nm. As another example, the second light source may be configured to generate second light having a second peak wavelength of 1600 nm.

In some embodiments, the first light source 112 and the second light source 114 may be configured to generate, respectively, light having a first peak wavelength and light having a second peak wavelength, the first peak wavelength and the second peak wavelength having values that are at least a threshold difference value apart from one another. For example, the difference in peak wavelength value between the first peak wavelength and the second peak wavelength may be at least 500 nm. In some embodiments, the difference in peak wavelength value between the first peak wavelength and the second peak wavelength may be in a range from 250 nm to 750 nm.

In some embodiments, the first light source 112 and/or the second light source 114 may include one or more laser light source, super-luminescent diode (SLD) light source, laser diode light source, light emitting diode (LED) light source, solid-state laser light source, quantum well or quantum dot laser light source, and/or any other suitable light source. The first light source 112 and the second light source 114 may both be a same type of light source or may be different types of light sources, as aspects of the technology described herein are not limited in this respect.

In some embodiments, the first light source 112 and/or the second light source 114 may be configured to generate the first light and/or the second light with an optical power sufficient for annealing the optical fiber 120. For example, the first light source 112 and/or the second light source 114 may be configured to generate the first light and/or the second light having an optical power in a range from 5 mW to 1 W, in a range from 5 mW to 500 mW, in a range from 10 mW to 600 mW, in a range from 15 mW to 500 mW, or any suitable range within those ranges. For example, the first light source and/or the second light source may be configured to generate light having an optical power of approximately 10 mW, 20 mW. 50 mW, 100 mW, 200 mW, 250 mW, and/or 500 mW.

In some embodiments, the optical multiplexer 116 is arranged to multiplex the first light and/or the second light onto the optical fiber 120. In some embodiments, the optical multiplexer 116 may be arranged to multiplex the first light and the second light onto the optical fiber 120 simultaneously such that the optical fiber 120 is illuminated by both the first light and the second light. For example, the optical multiplexer 116 may be arranged to perform wavelength-division multiplexing (WDM). In some embodiments, the optical multiplexer 116 may be arranged to multiplex the first light and the second light onto the optical fiber 120 in an alternating sequence such that the optical fiber 120 is alternatingly illuminated by the first light and then the second light. For example, the optical multiplexer 116 may be arranged to perform time-division multiplexing (TDM). In some embodiments, the first light and the second light may be time-division multiplexed onto the optical fiber 120 with a frequency equal to or greater than 50 Hz.

In some embodiments, the controller 130 may be used to control one or more components of the optical system 110. For example, the controller 130 may be configured to, during operation of the system 100, turn on and/or off each of first light source 112 and second light source 114. The controller 130 may alternatively or additionally be configured to control optical multiplexer 116 to multiplex the first and/or second light onto the optical fiber 120.

In some embodiments, the controller 130 may include one or more processors and a non-transitory computer-readable medium (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on the one or more processors, perform methods that implement the various embodiments of the present disclosure described above. The computer-readable medium or media may be located adjacent the optical system 110 (e.g., in a same room or same facility), or in some embodiments, may be located remotely from the optical system 110 (e.g., communicatively coupled over a network or the cloud).

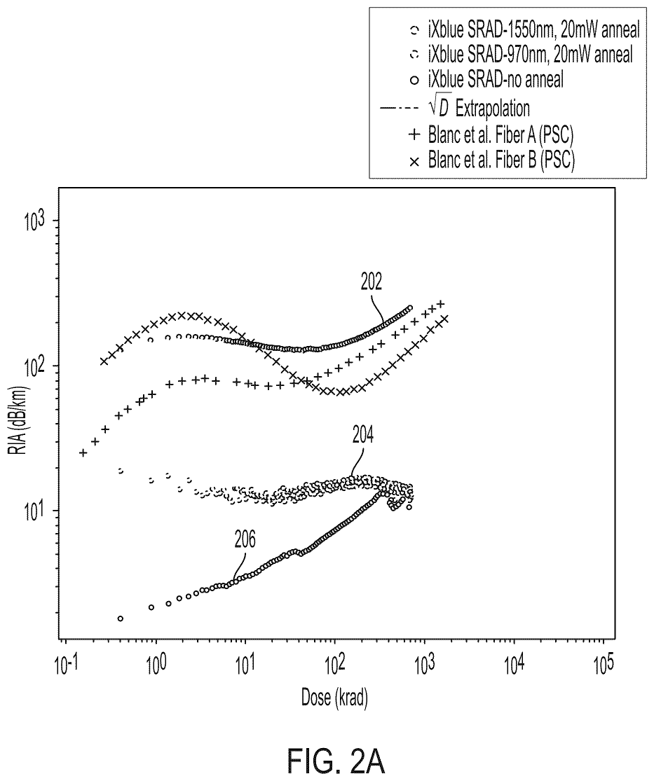

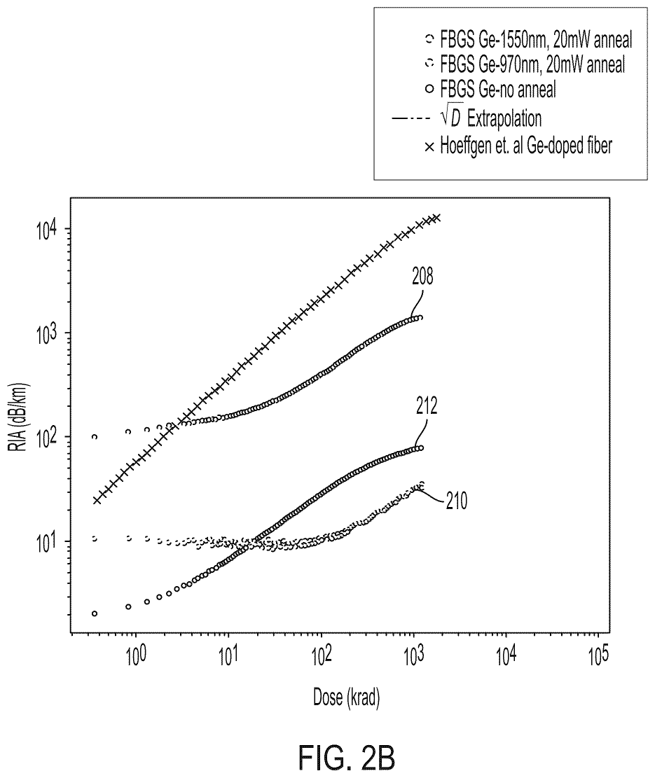

Effects of optical annealing using light having two different peak wavelengths on two different optical fibers are shown in FIGS. 2A and 2B. FIG. 2A illustrates the effects of optical annealing effects on an IXF-SRAD fiber manufactured by iXblue, in accordance with some embodiments of the technology described herein. Curve 202 shows measured RIA as a function of radiation dose when no optical annealing is performed. Curve 204 shows measured RIA as a function of radiation dose when the fiber is optically annealed with light at a wavelength of 970 nm and an optical power of 20 mW. Curve 206 shows measured RIA as a function of radiation dose when the fiber is optically annealed with light at a wavelength of 1550 nm and an optical power of 20 mW. As shown by FIG. 2A, both curves 206 and 208 show a reduction in RIA by an order of magnitude compared to curve 202, with curve 206 showing very low RIA at low radiation doses.

FIG. 2B illustrates the effects of optical annealing on a Low Bend Loss (LBL) fiber manufactured by FBGS, in accordance with some embodiments described herein. Curve 208 shows measured RIA as a function of radiation dose when no optical annealing is performed. Curve 210 shows measured RIA as a function of radiation dose when the fiber is optically annealed with light at a wavelength of 970 nm and an optical power of 20 mW. Curve 212 shows measured RIA as a function of radiation dose when the fiber is optically annealed with light at a wavelength of 1550 nm and an optical power of 20 mW. As shown by FIG. 2B, both curves 210 and 212 show a reduction in RIA by an order of magnitude compared to curve 208, with curve 212 showing very low RIA at low radiation doses.

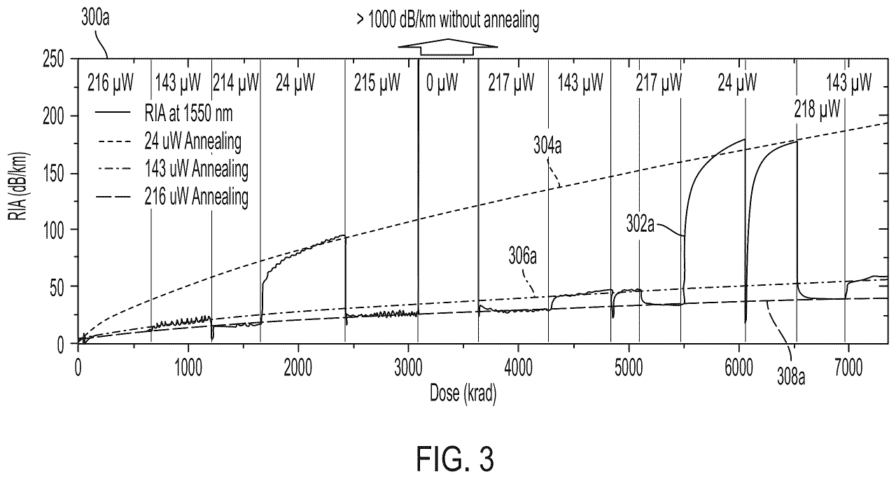

FIG. 3 is a plot illustrating optical annealing effects of light applied to an optical fiber with different values of optical power and over a period of four days, in accordance with some embodiments described herein. The top plot 300a and the bottom plot 300b include data from two separate annealing tests performed on a same optical fiber using light having a peak wavelength of approximately 1550 nm and 970 nm, respectively. The optical power applied is shown along the top axis of each plot 300a, 300b and includes optical powers having values of approximately 0 μW, 24 μW, 143 μW, and 214-218 μW.

Curves 302a and 302b show RIA as a function of dose over the course of the experiment. Curves 304a and 304b show an extrapolated RIA over time for optical annealing performed with an optical power of approximately 24 μW, curves 306a and 306b show an extrapolated RIA over time for optical annealing performed with an optical power of approximately 143 μW, and curves 308a and 308b show an extrapolated RIA over time for optical annealing performed with an optical power of approximately 214-218 μW. The use of lower optical powers for optical annealing correlate with larger RIA for both curves 302a and 302b and larger extrapolated RIA as shown by curves 304a and 304b as compared to curves 306a and 308a or curves 306b and 308b, respectively.

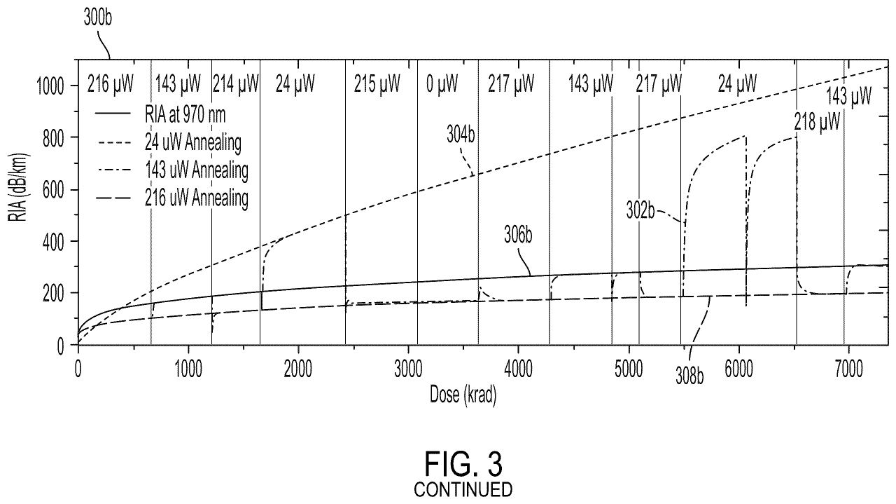

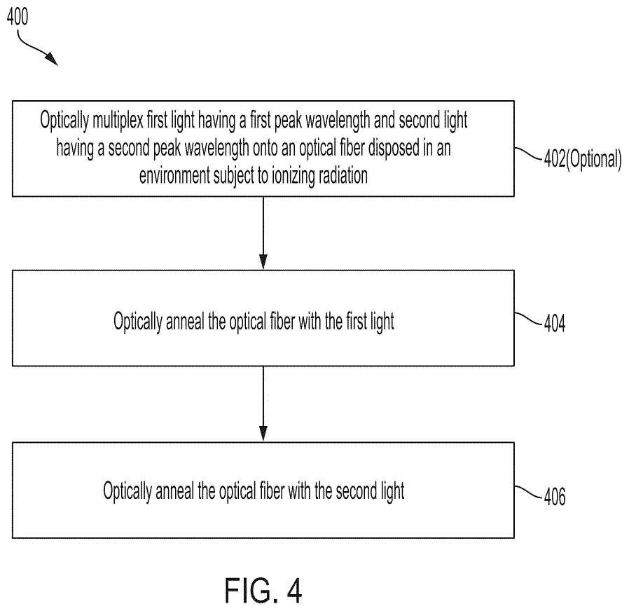

FIG. 4 is a flowchart of a process 400 of optically annealing an optical fiber disposed in an environment subject to ionizing radiation, in accordance with some embodiments described herein. Process 400 may be controlled using any suitable computing device. For example, in some embodiments, the process 400 may be performed by a computing device co-located (e.g., in the same room or facility) with an optical system configured to perform optical annealing (e.g., optical system 110 as described in connection with FIG. 1). As another example, in some embodiments, the process 400 may be performed by one or more processors located remotely from the optical system that performs the optical annealing.

Process 400 may optionally begin at act 402, where two or more optical signals (e.g., light) having different peak wavelengths may be multiplexed onto an optical fiber disposed in an environment subject to ionizing radiation. In some embodiments, multiplexing the two or more optical signals may be performed using WDM and/or TDM. For example, first light and second light may be multiplexed onto the optical fiber using WDM and/or TDM.

Process 400 may alternatively begin at act 404, or, after act 402, process 400 may proceed to act 404 in which the fiber is optically annealed with the first light. In some embodiments, optically annealing the optical fiber with the first light may include illuminating the optical fiber with first light having a peak wavelength in a range from 770 nm to 1170 nm. For example, in some embodiments, optically annealing the optical fiber with the first light may include illuminating the optical fiber with first light having a peak wavelength of approximately 970 nm.

After act 404, process 400 may then proceed with act 406 where the fiber is optically annealed with the second light. In some embodiments, optically annealing the optical fiber with the second light may include illuminating the optical fiber with second light having a peak wavelength in a range from 1350 nm to 1750 nm. For example, in some embodiments, optically annealing the optical fiber with the second light may include illuminating the optical fiber with second light having a peak wavelength of approximately 1550 nm.

In some embodiments, acts 404 and 406 may be performed simultaneously such that optically annealing the optical fiber with the first light and the second light includes optically annealing the optical fiber with the first light and the second light simultaneously. To optically anneal the optical fiber with the first light and the second light simultaneously, the first light and the second light may be wavelength-division multiplexed onto the optical fiber, in some embodiments.

In some embodiments, acts 404 and 406 may be performed sequentially such that optically annealing the optical fiber with the first light and the second light includes optically annealing the optical fiber with the first light and the second light in an alternating sequence. To optically anneal the optical fiber with the first light and the second light in an alternating sequence, the first light and the second light may be time-division multiplexed onto the optical fiber, in some embodiments.

In some embodiments, acts 404 and/or 406 may include optically annealing the optical fiber with the first and/or second light while the optical fiber is exposed to the ionizing radiation. For example, the ionizing radiation may be generated by an artificial or manmade source (e.g., a fusion energy source). The ionizing radiation incident on the optical fiber may have a dose rate greater than a dose rate of background ionizing radiation (e.g., from cosmic rays and other background ionizing radiation sources). For example, the ionizing radiation incident on the optical fiber may have a dose rate greater than 0.2 nGy/s.

In some embodiments, acts 404 and/or 406 may include optically annealing the optical fiber with the first light and/or the second light while the optical fiber is disposed in a cryogenic environment. For example, the optical fiber may be disposed in an environment at a temperature in a range from 0K to 120K.

In some embodiments, acts 404 and/or 406 may include annealing the optical fiber with the first light and/or the second light while the optical fiber is disposed adjacent a superconducting material. For example, the optical fiber may be disposed along a length of at least one high temperature superconductor (HTS) tape stack.

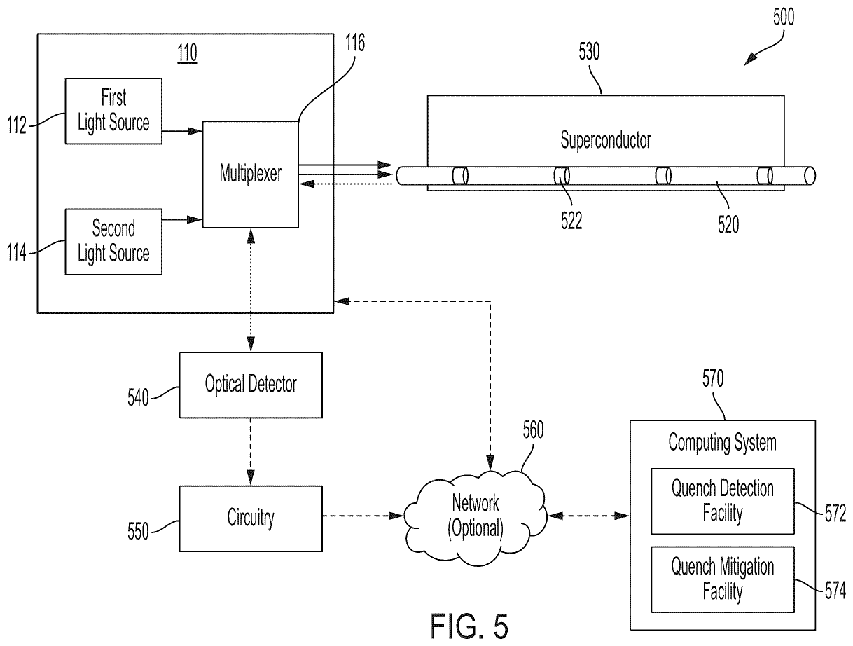

FIG. 5 is a schematic diagram of an illustrative system 500 of the use of optical system 110 to detect quench events in a superconductor 530. Superconductors are materials that have nearly zero electrical resistance to current (are “superconducting”) below a critical temperature. Superconductors have found applications in fusion energy, high-efficiency motors, high-efficiency power transmission, magnetic resonance imaging (MRI), nuclear magnetic resonance (NMR), and high-field particle accelerators. To remain in a superconducting state, the superconducting material needs to remain at a temperature below the critical temperature. However, localized energy dissipation (e.g., due to current flow in the superconductor) can cause localized heating, which, if not controlled or detected, may result in a thermal runaway event that causes the entire superconductor to transition (to “quench”) from the superconducting regime to a normal, resistive regime. A quench event not only can result in downtime of the superconducting device but may result in damage to the superconducting device as well.

The inventors have recognized and appreciated that optical systems are not susceptible to electromagnetic interference and may be used to develop more robust and accurate optics-based quench detection systems. Such optics-based quench detection systems may use fiber optic thermometry, which measures the temperature and strain response of optical fibers, to detect quench events by embedding the fiber optic cable in or adjacent the superconductor. The optical fibers used in such optics-based quench detection systems may include a number of Bragg gratings (e.g., fiber Bragg gratings (FBGs), ultra-long fiber Bragg gratings (ULFBGs)) which are configured to reflect a portion of any light that is incident on the Bragg gratings. The spectra of the reflected light may indicate a change in temperature and/or strain experienced by the Bragg gratings such that a quench event can be detected by analyzing the spectra of reflected light.

The inventors have recognized and appreciated that optical systems may be used to develop more robust and accurate optics-based quench detection systems. Such optics-based quench detection systems may use fiber optic thermometry, which measures the temperature and strain response of optical fibers, to detect quench events by embedding the fiber optic cable in or adjacent the superconductor. The optical fibers used in such optics-based quench detection systems may include a number of Bragg gratings (e.g., fiber Bragg gratings (FBGs), ultra-long fiber Bragg gratings (ULFBGs)) which are configured to reflect a portion of any light that is incident on the Bragg gratings. The spectra of the reflected light may indicate a change in temperature and/or strain experienced by the Bragg gratings such that a quench event can be detected by analyzing the spectra of reflected light.

In the illustrative example of FIG. 5, the system 500 includes an optical system 110 (e.g., optical system 110 as described in connection with FIG. 1), a superconductor 530, an optical fiber 520, an optical detector 540, circuitry 550, optionally a network 560, and a computing system 570. It should be appreciated that system 500 is illustrative and that a quench detection system may have one or more other components of any suitable type in addition to or instead of the components illustrated in FIG. 5. For example, there may be additional computing systems (e.g., two or more) present within a quench detection system. As another example, in some embodiments, the optical system 110, optical detector 540, and/or circuitry 550 may be combined into a single device (e.g., disposed in a single housing).

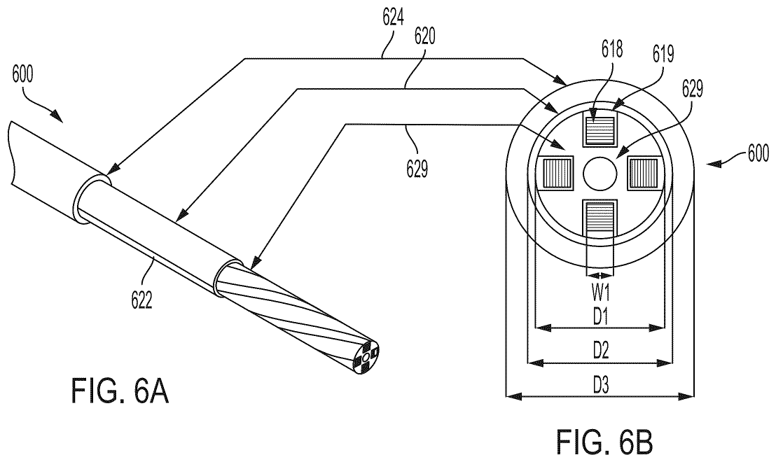

In some embodiments, the superconductor 530 may be any suitable superconducting material. For example, the superconductor 530 may include a LTS and/or a HTS material. In some embodiments, the superconductor 530 may be arranged to form a superconducting electromagnet and/or power transmission line, such as for use in motor, power transmission, MRI, NMR, particle accelerator, and/or fusion energy systems. In some embodiments, the superconductor 530 may include one or more HTS tape stacks, as described in more detail in connection with FIGS. 6A and 6B herein.

In some embodiments, the optical fiber 520 may be in thermal contact with the superconductor 510. For example, the optical fiber 520 may be disposed proximate the superconductor 510 and/or may be embedded in the superconductor 510. It should be appreciated that while the example of FIG. 5 shows a single optical fiber 520, aspects of the technology described herein are not limited in this respect. In some embodiments, there may be multiple optical fibers. For example, there may be a number of optical fibers in a range from 2 to 50, from 2 to 25, from 2 to 10, or from 2 to 7, or within any range within these ranges.

In some embodiments, the optical fiber 520 may include a number of gratings 522 disposed along the length of the optical fiber 520. The gratings may be diffraction gratings configured to reflect particular wavelengths of light and to transmit other wavelengths of light. For example, the gratings 522 may be fiber Bragg gratings (FBGs) or ultra-long fiber Bragg gratings (ULFBGs). The illustration of FIG. 5 shows four gratings 522 that are evenly spaced, but it should be appreciated that there may be greater than four gratings 522 that may be evenly spaced or non-evenly spaced, as aspects of the technology described herein are not limited as to the number of gratings 522 or their spacing. In some embodiments, the gratings 522 may be spaced by one or more distances suitable for detecting a quench event within a short enough time period that stored energy within the superconductor 510 can be removed prior to damaging the superconductor 530 or other components of the device housing the superconductor 530.

As illustrated in FIG. 5, system 500 includes optical system 110 optically coupled to the optical fiber 520 and optical detector 540 optically coupled to the optical system 110. As described in connection with FIG. 1, the optical system 110 may include a first light source 112, a second light source 114, and an optical multiplexer 116. The first light source 112 and the second light source 114 may be configured to generate first and second light that is provided to the optical fiber 520 to perform both optical annealing of the optical fiber 520 and optical quench detection. The light generated by one of the first light source 112 or the second light source 114 may have a peak wavelength centered around or near the Bragg wavelength of the gratings 522 of the optical fiber 520 at the operating temperature of the superconductor 530.

In some embodiments, during operation of the system 500, the optical system 110 may provide light to the optical fiber 520 from the first light source 112 and the second light source 114 (e.g., simultaneously, sequentially, etc.). The provided light may illuminate and optically anneal the optical fiber 520. Additionally, light provided having a peak wavelength centered around or near the Bragg wavelength of the gratings 522 may be reflected and returned to the optical system 110. The optical multiplexer 116 may demultiplex or otherwise isolate this returned light for analysis and quench detection. It should be appreciated that in some embodiments, the light having a peak wavelength centered around or near the Bragg wavelength may be analyzed after being transmitted through the optical fiber 520 rather than analyzing the reflected light, as aspects of this technology are not limited in this respect.

In some embodiments, the optical detector 540 may be configured to detect the light that is reflected or transmitted by the gratings 522 of optical fiber 520. For example, the optical detector 540 may be configured to detect a spectrum of the received light 542, an intensity, and/or to determine a peak wavelength of the received light. In some embodiments, the optical detector 540 may be an optical spectrum analyzer (OSA), an integrating sphere detector, a wavelength meter, or any other suitable optical detector. In some embodiments, the optical detector 540 may be an interrogator configured to both send and receive light separate from the light generated by the first light source 112 and the second light source 114.

In some embodiments, the optical detector 540 may be coupled to circuitry 550. Circuitry 550 may be configured to determine a temperature of the superconductor 530 based on the output of the optical detector 540. For example, circuitry 550 may be configured to receive an optical spectrum from the optical detector 540, to determine a peak wavelength of the received optical spectrum, and to determine a temperature corresponding to that peak wavelength. Circuitry 550 may be implemented using any suitable electronic circuitry, including but not limited to FPGA, ASIC, a microcontroller, and/or other microprocessing technologies. In some embodiments, circuitry 550 may include controller 130, as described in connection with FIG. 1 herein.

In some embodiments, the system 500 includes computing system 570 communicatively coupled to the circuitry 550. The computing system 570 may be any suitable electronic device configured to receive information from the circuitry 550 and/or to process information received from the circuitry 550. In some embodiments, the computing system 570 may be a fixed electronic device such as a desktop computer, a rack-mounted computer, or any other suitable fixed electronic device. Alternatively, the computing system 570 may be a portable device such as a laptop computer, a smart phone, a tablet computer, or any other portable device that may be configured to receive information from circuitry 550 and/or to process information received from the circuitry 550.

In some embodiments, the circuitry 550 and the computing system 570 may be communicatively connected by an optional network 560. The network 560 may be or include one or more local- and/or wide-area, wired and/or wireless networks, including a local-area or wide-area enterprise network and/or the Internet. Accordingly, the network 560 may be, for example, a hard-wired network (e.g., a local area network within a facility), a wireless network (e.g., connected over Wi-Fi and/or cellular networks), a cloud-based computing network, or any combination thereof. For example, in some embodiments, the superconductor 530, optical fiber 520, optical system 110, optical detector 540, and the circuitry 550 may be located within a same facility and connected directly to each other or connected to each other via the network 560, while the computing system 570 may be located in a remote facility and connected to the circuitry 550 through the network 560. It should be appreciated that in some embodiments, however, the computing system 570 may be connected directly to the circuitry 550 rather than being connected by the network 560, as aspects of the technology described herein are not limited in this respect.

In some embodiments, the computing system 570 may include a quench detection facility 572. The quench detection facility 572 may be configured to analyze data obtained by the optical detector 540 and processed by circuitry 550. The quench detection facility 572 may be configured to, for example, analyze the temperature data output by circuitry 550 to determine whether a quench event is about to occur and/or is presently occurring in the superconductor 530. For example, the quench detection facility 572 may be configured to determine whether the temperature data output by the circuitry 550 is greater than a threshold temperature value and/or to fit a function to the temperature data over time to determine whether a thermal runaway event is about to occur and/or is presently occurring.

In some embodiments, the computing system 570 may further include a quench mitigation facility 574. The quench mitigation facility 574 may be configured to generate instructions to cause the removal of energy from the superconductor 530 in response to a determination by the quench detection facility 572 of a quench event. For example, the quench mitigation facility 574 may be configured to generate instructions to cause a removal of current flowing in the superconductor 530 (e.g., by shunting or otherwise shorting the superconductor 530) to remove energy stored in the superconductor 530.

The quench detection facility 572 and/or the quench mitigation facility 574 may be implemented as hardware, software, or any suitable combination of hardware and software, as aspects of the technology described herein are not limited in this respect. As illustrated in FIG. 5, the quench detection facility 572 and the quench mitigation facility 574 may be implemented by the computing system 570, such as by being implemented in software (e.g., executable instructions) executed by one or more processors of the computing system 570. However, in other embodiments, the quench detection facility 572 and/or the quench mitigation facility 574 may be additionally or alternatively implemented at one or more other elements of the system 500, for example, the quench detection facility 572 and/or the quench mitigation facility 574 may be implemented at the circuitry 550. In other embodiments, the quench detection facility 572 and/or the quench mitigation facility 574 may be implemented at or with another device, such as a computing device located remotely from the system 500 and receiving data via the network 560.

In the example of FIG. 5, superconductor 530 may correspond to high temperature superconducting (HTS) cables. As may be seen in FIGS. 6A and 6B, a HTS cable 600 includes a former 616 having HTS tape stacks 618 disposed in channels provided in an exterior surface of and extending along a length of the former 616. HTS tape stacks 618 are held in their respective channels via solder 619. An inner jacket 620 (e.g., a copper jacket) is disposed around the former 616 and HTS tape stacks 618 and a plating 622 (e.g., a silver plating) may be disposed over the inner jacket 620. Although the entire surface of inner jacket 620 may be plated, in some embodiments, only a portion of inner jacket 620 may be plated. Thus, as illustrated in FIG. 6A, only about one-half of the surface of inner jacket 620 has a plating 622 disposed thereover. An outer jacket 624 (e.g., a steel or stainless-steel jacket) is disposed around inner jacket 620.

In this example embodiment, the cable 600 has multiple channels in an electrically conductive (e.g., copper) former surrounded by one or more jackets. Each channel has an HTS tape stack and is filled with a metal (e.g., a solder). Cable 600 also includes an optional cooling channel 629.

As shown in FIG. 6B, the width of an illustrative channel is W1, the diameter of the former 616 is D1, the diameter of the inner jacket 620 is D2, and the diameter of the outer jacket 624 is D3. In some embodiments, the inner jacket 620 may comprise copper and the outer jacket 624 may comprise stainless steel. However, this is merely by way of example, as other suitable materials for the jackets and former may be used.

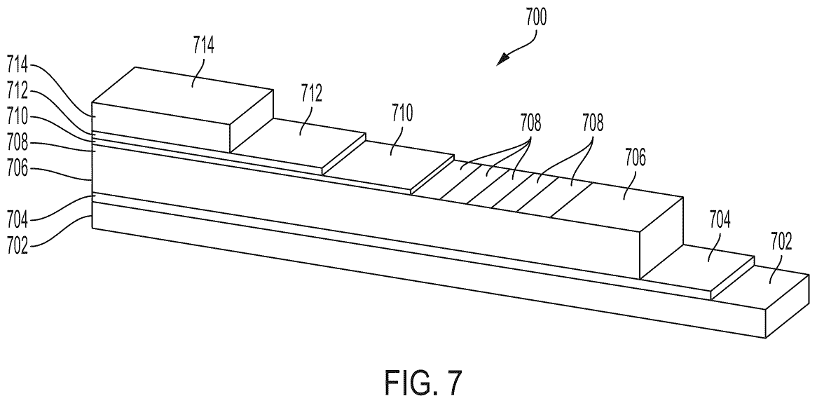

Referring now to FIG. 7, an illustrative HTS tape stack 700 includes a first layer 702 corresponding to a first stabilizer layer (here stabilizer layer 702 comprises copper). Disposed over layer 702 is an overlay layer 704 (here overlay 702 comprises silver). A substrate 706 is disposed over layer 704. In this example, substrate 706 may be provided from any suitable material and is provided having an electropolished surface. A buffer stack 708 is disposed over the substrate 706. In this example, buffer stack 708 may comprise one or more materials disposed via a magnetron sputtering technical. An HTS material 710 is disposed over buffer stack 708. In this illustrative embodiment, HTS material may comprise a rare earth barium copper oxide superconductor (REBCO) such as yttrium barium copper oxide (YBCO). Disposed over HTS material layer 710 is an overlayer 712 and disposed over overlay 712 is a second stabilizer layer 714. Overlayer 712 and stabilizer layer 714 may comprise the same materials as overlay 704 and stabilizer layer 702, respectively, as described above.

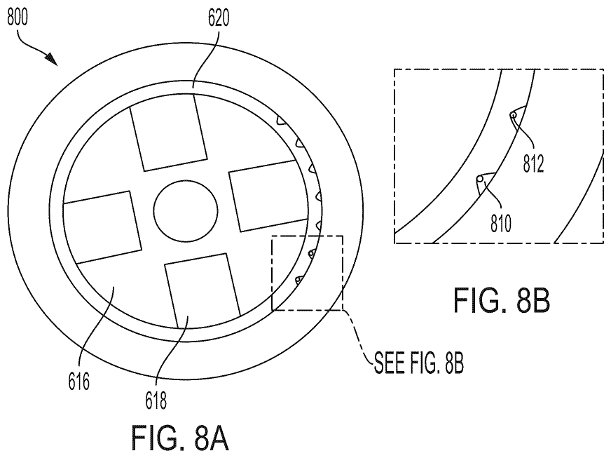

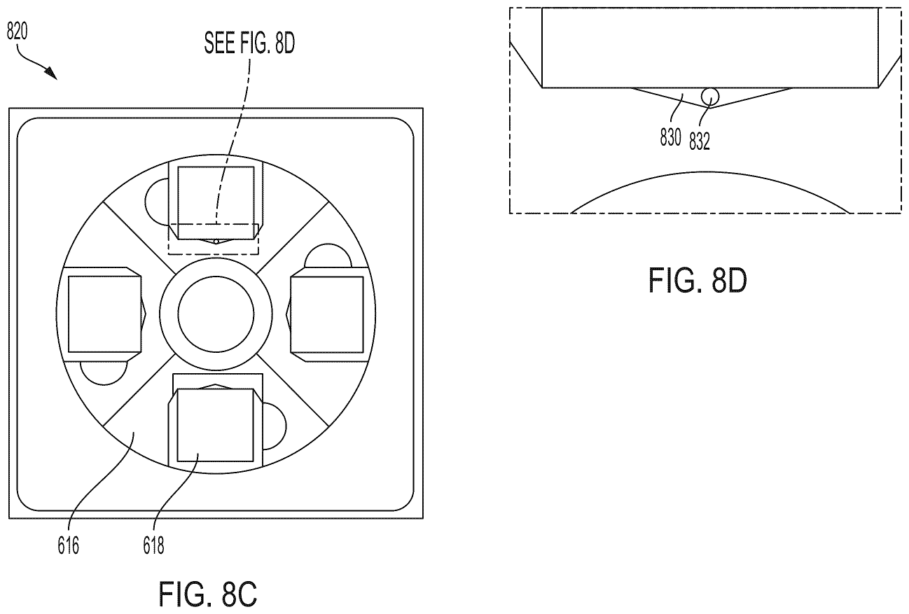

Referring now to FIGS. 8A and 8B, an HTS cable 800 may include one or more grooves 810 configured to accept optical fibers 812. As shown in FIGS. 8A and 8B, the grooves 810 may be disposed on an outer surface of the inner jacket 620 of the HTS cable 800. In some embodiments, the grooves 810 may be disposed in other surfaces of the HTS cable 800 (e.g., on an inner surface of the inner jacket 620, on an inner surface of the cooling channel 629).

The grooves 810 may extend along the length of the HTS cable 800, in some embodiments. The grooves may be disposed on one side of the HTS cable 800, as shown in the example of FIG. 8A. In some embodiments, the grooves 810 and optical fibers 812 may be arranged around a smaller or greater portion, including an entirety, of the circumference of the cable 800.

In some embodiments, the optical fibers 812 may be secured in the grooves 810 using an adhesive. For example, the optical fibers 812 may be secured in the grooves 810 using a thermally conductive adhesive (e.g., silver adhesive) to ensure thermal coupling between the optical fibers 812 and the former 616 and the HTS tape stacks 618. As another example, the optical fibers 812 may be secured in the grooves 810 using solder.

An optical fiber 812 may be located at any position within or proximate the HTS cable 800. In some embodiments, the optical fibers 812 may be disposed on a surface of the HTS cable 800 rather than being disposed in grooves (e.g., grooves 810). For example, the optical fibers 812 may be adhered to any suitable surface (e.g., the outer or inner surface of the inner jacket 620, the inner surface of the cooling channel 629) of the HTS cable 800 using an adhesive (e.g., a thermally conductive adhesive).

FIGS. 8C and 8D show an alternative HTS cable 820 including grooves 830 formed on an inner surface of the former 616 such that the optical fibers 832 are disposed between the HTS tape stacks 618 and the former 616. In some embodiments, the grooves 830 may be filled with solder (e.g., to adhere the HTS tape stacks 618 to the former 616). The optical fibers 832 may be embedded in the solder such that the solder adheres the optical fibers 832 within the grooves 830.

In some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility.” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application, for example as a software program application such as a quench detection facility.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

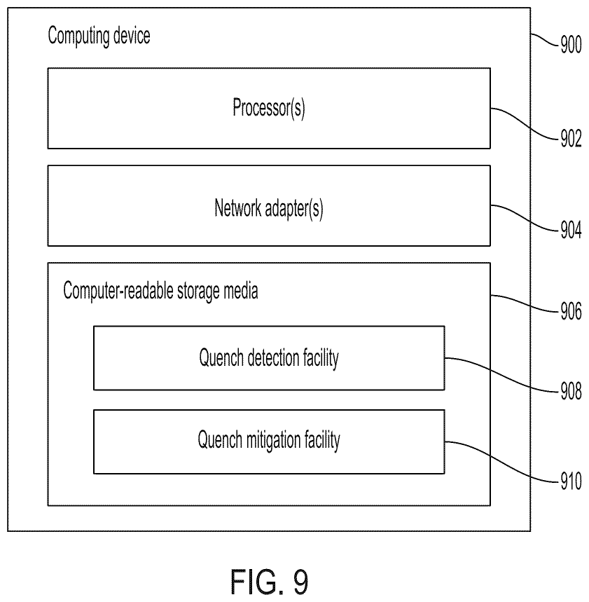

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 906 of FIG. 9 described below (i.e., as a portion of a computing device 900) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 9, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing devices (co-located or geographically distributed) dedicated to executing the techniques described herein, one or more Field-Programmable Gate Arrays (FPGAs) for carrying out the techniques described herein, or any other suitable system.

FIG. 9 illustrates one exemplary implementation of a computing device in the form of a computing device 900 that may be used in a system implementing techniques described herein, although others are possible. It should be appreciated that FIG. 9 is intended neither to be a depiction of necessary components for a computing device to operate as a quench detection system and/or a quench mitigation system in accordance with the principles described herein, nor a comprehensive depiction.

Computing device 900 may comprise at least one processor 902, a network adapter 904, and computer-readable storage media 906. Computing device 900 may be, for example, a desktop or laptop personal computer, a personal digital assistant (PDA), a smart mobile phone, or any other suitable computing device. Network adapter 904 may be any suitable hardware and/or software to enable the computing device 900 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 906 may be adapted to store data to be processed and/or instructions to be executed by processor 902. Processor 902 enables processing of data and execution of instructions. The data and instructions may be stored on the computer-readable storage media 906.

The data and instructions stored on computer-readable storage media 906 may comprise computer-executable instructions implementing techniques which operate according to the principles described herein. In the example of FIG. 9, computer-readable storage media 906 stores computer-executable instructions implementing various facilities and storing various information as described above. Computer-readable storage media 906 may store quench detection facility 908 configured to derive information indicative of a quench event from fiber optic thermometry data and/or quench mitigation facility 910 configured to cause the removal of stored energy from a superconducting material in the event that a quench event is detected.

While not illustrated in FIG. 9, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Having thus described several aspects of at least one embodiment of this technology, it is to be appreciated that various alterations, modifications, and improvements will readily occur to those skilled in the art.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the technology described herein may be embodied as a method, examples of which are provided herein including with reference to FIG. 4. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The terms “approximately” and “about” may be used to mean within ±20% of a target value in some embodiments, within ±10% of a target value in some embodiments, within ±5% of a target value in some embodiments, within ±2% of a target value in some embodiments. The terms “approximately” and “about” may include the target value.

What is claimed is:

1. A system arranged to perform optical annealing of an optical fiber disposed in an environment subject to ionizing radiation, the system comprising:
a first light source configured to illuminate and optically anneal the optical fiber by generating first light having a first peak wavelength;
a second light source configured to illuminate and optically anneal the optical fiber by generating second light having a second peak wavelength; and
an optical multiplexer coupled between the first light source and the optical fiber and between the second light source and the optical fiber.

2. The system of claim 1, wherein the first light source is configured to generate the first light having the first peak wavelength in a range from 770 nm to 1170 nm.

3. The system of claim 1 or claim 2, wherein the first light source is configured to generate the first light having the first peak wavelength of approximately 970 nm.

4. The system of any one of claims 1 to 3, wherein the second light source is configured to generate the second light having the second peak wavelength in a range from 1350 nm to 1750 nm.

5. The system of any one of claims 1 to 4, wherein the second light source is configured to generate the second light having the second peak wavelength of approximately 1550 nm.

6. The system of any one of claims 1 to 5, wherein the first light source is configured to generate the first light having an optical power in a range from 5 mW to 500 mW.

7. The system of any one of claims 1 to 6, wherein the optical multiplexer is configured to perform wavelength-division multiplexing (WDM) of the first light and the second light.

8. The system of any one of claims 1 to 7, wherein the optical multiplexer is configured to perform time-division multiplexing (TDM) of the first light and the second light.

9. The system of any one of claims 1 to 8, wherein the optical multiplexer is configured to simultaneously illuminate the optical fiber with the first light and the second light.

10. The system of any one of claims 1 to 9, wherein the optical multiplexer is configured to illuminate the optical fiber with the first light and the second light in an alternating sequence.

11. The system of any one of claims 1 to 10, wherein the system is arranged to illuminate the optical fiber using the first light source and/or second light source while the optical fiber is exposed to the ionizing radiation.

12. The system of any one of claims 1 to 11, wherein the optical fiber is disposed in a cryogenic environment while illuminated by the first light source and/or the second light source.

13. The system of any one of claims 1 to 12, wherein the optical fiber is at a temperature between 0K and 120K while illuminated by the first light source and/or the second light source.

14. The system of any one of claims 1 to 13, wherein the optical fiber extends along a length of a high temperature superconductor (HTS) cable, the HTS cable comprising at least one HTS tape stack.

15. The system of any one of claims 1 to 14, wherein the system is used in a fusion energy system.

16. The system of any one of claims 1 to 15, wherein the ionizing radiation is manmade ionizing radiation.

17. The system of any one of claims 1 to 16, wherein a dose rate of the ionizing radiation on the environment is greater than a dose rate of background ionizing radiation.

18. The system of any one of claims 1 to 17, wherein the dose rate of the ionizing radiation is greater than 0.2 nGy/s.

19. A method of optically annealing an optical fiber disposed in an environment subject to ionizing radiation, the method comprising:
optically annealing the optical fiber with first light having a first peak wavelength; and
optically annealing the optical fiber with second light having a second peak wavelength.

20. The method of claim 19, wherein optically annealing the optical fiber with the first light and the second light comprises optically annealing the optical fiber with the first light and the second light simultaneously.

21. The method of claim 19 or claim 20, wherein optically annealing the optical fiber with the first light and the second light comprises optically annealing the optical fiber with the first light and the second light in an alternating sequence.

22. The method of any one of claims 19 to 21, wherein optically annealing the optical fiber with the first light and the second light comprises multiplexing the first light and the second light onto the optical fiber.

23. The method of any one of claims 19 to 22, wherein multiplexing the first light and the second light onto the optical fiber comprises using wavelength-division multiplexing (WDM).

24. The method of any one of claims 19 to 23, wherein multiplexing the first light and the second light onto the optical fiber comprises using time-division multiplexing (TDM).

25. The method of any one of claims 19 to 24, wherein optically annealing the optical fiber with the first and/or second light comprises optically annealing the optical fiber with the first and/or second light while the optical fiber is exposed to the ionizing radiation.

26. The method of any one of claims 19 to 25, wherein optically annealing the optical fiber with the first light comprises illuminating the optical fiber with first light having a peak wavelength in a range from 770 nm to 1170 nm.

27. The method of any one of claims 19 to 26, wherein optically annealing the optical fiber with the first light comprises optically annealing the optical fiber with first light having a peak wavelength of approximately 970 nm.

28. The method of any one of claims 19 to 27, wherein optically annealing the optical fiber with the second light comprises optically annealing the optical fiber with second light having a peak wavelength in a range from 1350 nm to 1750 nm.

29. The method of any one of claims 19 to 28, wherein optically annealing the optical fiber with the second light comprises optically annealing the optical fiber with second light having a peak wavelength of approximately 1550 nm.

30. The method of any one of claims 19 to 29, wherein optically annealing the optical fiber with the first light and/or the second light comprises optically annealing the optical fiber with the first light and/or the second light while the optical fiber is disposed in a cryogenic environment.

31. The method of any one of claims 19 to 30, wherein optically annealing the optical fiber with the first light and/or the second light comprises optically annealing the optical fiber with the first light and/or the second light while the optical fiber is at a temperature between 0K and 120K.

32. The method of any one of claims 19 to 31, wherein optically annealing the optical fiber with the first light and/or the second light comprises optically annealing the optical fiber with the first light and/or the second light while the optical fiber is disposed along a length of a high temperature superconductor (HTS) cable, the HTS cable comprising at least one HTS tape stack.

33. The method of any one of claims 19 to 32, wherein optically annealing the optical fiber with the first light and/or the second light comprises optically annealing the optical fiber with the first light and/or the second light while the optical fiber is used in a fusion energy system.

34. A system arranged to perform optical annealing of an optical fiber, the system comprising:
a first light source configured to optically anneal the optical fiber by generating first light having a first peak wavelength;
a second light source configured to optically anneal the optical fiber by generating second light having a second peak wavelength; and
an optical multiplexer coupled between the first light source and the optical fiber and between the second light source and the optical fiber, wherein:
the optical fiber is disposed in a fusion energy source,
the optical fiber is subject to ionizing radiation created by the fusion energy source while the first light source and/or the second light source optically anneal the optical fiber, and
the optical fiber is at a cryogenic temperature.

35. The system of claim 34, wherein the first light source is configured to generate the first light having the first peak wavelength in a range from 770 nm to 1170 nm.

36. The system of claim 34 or claim 35, wherein the first light source is configured to generate the first light having the first peak wavelength of approximately 970 nm.

37. The system of any one of claims 34 to 36, wherein the second light source is configured to generate the second light having the second peak wavelength in a range from 1350 nm to 1750 nm.

38. The system of any one of claims 34 to 37, wherein the second light source is configured to generate the second light having the second peak wavelength of approximately 1550 nm.

39. The system of any one of claims 34 to 38, wherein the first light source is configured to generate the first light having an optical power in a range from 5 mW to 500 mW.

40. The system of any one of claims 34 to 39, wherein the optical multiplexer is configured to perform wavelength-division multiplexing (WDM) of the first light and the second light.

41. The system of any one of claims 34 to 40, wherein the optical multiplexer is configured to perform time-division multiplexing (TDM) of the first light and the second light.

42. The system of any one of claims 34 to 41 wherein the optical multiplexer is configured to simultaneously illuminate the optical fiber with the first light and the second light.

43. The system of any one of claims 34 to 42, wherein the optical multiplexer is configured to illuminate the optical fiber with the first light and the second light in an alternating sequence.

44. The system of any one of claims 34 to 43, wherein the optical fiber is at a temperature between 0K and 120K while illuminated by the first light source and/or the second light source.

45. The system of any one of claims 34 to 44, wherein the optical fiber extends along a length of a high temperature superconductor (HTS) cable, the HTS cable comprising at least one HTS tape stack.
